(19) United States
(12) Patent Application Publication
(10) Pub. No.: US 2026/0188565 A1
(43) Pub. Date: Jul. 2, 2026

(54) COIL COMPONENT

(71) Applicant: SAMSUNG ELECTRO-MECHANICS CO., LTD., Suwon-si (KR)

(72) Inventors: Sang Jong Lee, Suwon-si (KR); Seong Hwan Lee, Suwon-si (KR); Min Cheol Park, Suwon-si (KR)

(73) Assignee: SAMSUNG ELECTRO-MECHANICS CO., LTD., Suwon-si (KR)

(21) Appl. No.: 19/365,934

(22) Filed: Oct. 22, 2025

(30) Foreign Application Priority Data
Dec. 26, 2024 (KR) 10-2024-0197279

(51) Int. Cl. H01F 27/29; H01F 27/32

(52) U.S. Cl. CPC H01F 27/292; H01F 27/324

(57) ABSTRACT

A coil component includes a body, a plurality of through-vias passing through the body, a plurality of pads disposed on one surface of the body, the plurality of pads respectively connected to the plurality of through-vias, a cover insulating layer covering one surface of the plurality of pads, an external electrode disposed on one surface of the cover insulating layer, and a via electrode passing through the cover insulating layer, the via electrode connecting the external electrode and the plurality of pads to each other.

### CROSS-REFERENCE TO RELATED APPLICATION(S)

This application claims benefit of priority to Korean Patent Application No. 10-2024-0197279 filed on Dec. 26, 2024 in the Korean Intellectual Property Office, the disclosure of which is incorporated herein by reference in its entirety.

### TECHNICAL FIELD

The present disclosure relates to a coil component.

An inductor, a coil component, may be a representative passive electronic component used in electronic devices, along with a resistor and a capacitor.

As electronic devices are designed to have higher performance and a reduced size, electronic components used in electronic devices have been increased in number and miniaturized.

Coil components have also been required to have a reduced size, and reducing a thickness of a coil component may be an important technical challenge. In addition, coil components have been required to secure a degree of design freedom to cope with various uses.

### SUMMARY

An aspect of the present disclosure is to provide a coil component having a reduced thickness.

Another aspect of the present disclosure is to provide a coil component having a high degree of design freedom, such as coil arrangement and connection.

According to an aspect of the present disclosure, there is provided a coil component including a body, a plurality of through-vias passing through the body, a plurality of pads disposed on one surface of the body, the plurality of pads respectively connected to the plurality of through-vias, a cover insulating layer covering one surface of the plurality of pads, an external electrode disposed on one surface of the cover insulating layer, and a via electrode passing through the cover insulating layer, the via electrode connecting the external electrode and the plurality of pads to each other.

According to example embodiments of the present disclosure, a coil component may have a reduced thickness.

According to example embodiments of the present disclosure, a coil component may have an improved degree of design freedom.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a coil component according to an example embodiment of the present disclosure;

FIG. 2 is a perspective view of internal elements of the coil component of FIG. 1;

FIG. 3 is a top view of the coil component of FIG. 1;

FIG. 4 is a cross-sectional view taken along line I-I′ of FIG. 3;

FIGS. 5A, 5B, 5C, and 5D are views of various connection examples of a plurality of through-vias;

FIGS. 6A, 6B, and 6C are views of coil components according to a modification of the present disclosure;

FIGS. 7A, 7B, and 7C are views of coil components according to another modification of the present disclosure;

FIGS. 8A, 8B, and 8C are views of coil components according to another modification of the present disclosure; and

FIGS. 9A, 9B, 9C, 9D, 9E, 9F, 9G, 9H, and 9I are views of a manufacturing process of a coil component according to the present disclosure.

### DETAILED DESCRIPTION

The terms used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this code, specify the presence of stated features, integers, steps, operations, elements, components or a combination thereof, but do not preclude the presence or addition of one or more other features, integers, steps, operations, elements, components, and/or groups thereof. In addition, the terms “disposed on,” “positioned on,” and the like, may mean that an element is positioned on or below a target portion, and may not necessarily mean that the element is positioned on an upper side of the target portion with respect to a direction of gravity.

In addition, as used herein, terms including an ordinal number such as “first” and “second” may be used to describe various elements, but the elements are not limited by the terms. The terms are only used to distinguish one element from another element.

In addition, when a portion, such as a layer, film, or the like, is described as being “on” or “above” another portion, it includes not only cases in which the portion is directly on the other portion but also cases in which another portion is interposed therebetween. In contrast, when a portion is described as being “directly on” another portion, it means that no other portion is interposed therebetween. In addition, when a portion is “on” or “above” a reference portion, it includes cases in which the portion is positioned on an upper portion or lower portion of the reference portion, and does not necessarily mean that the portion is positioned “on” or “above” the reference portion in a direction opposite to gravity.

The terms “coupled to,” “connected to,” and the like, may not only indicate that elements are directly and physically in contact with each other, but also include a configuration in which another element is interposed between the elements such that the elements are also in contact with the other element.

Throughout the specification, the term “connected” may not only mean that two or more elements are directly connected to each other, but may also means that the two or more elements are indirectly connected to each other, physically connected to each other, electrically connected to each other through another element, or may mean that the two or more elements are integrated with each other while being referred to by different names depending on positions or functions thereof.

The accompanying drawings are provided solely for the purpose of facilitating understanding of example embodiments disclosed herein. The technical spirit disclosed herein should not be construed as being limited by the drawings. It should be understood that the present disclosure encompasses all modifications, equivalents, and substitutes that fall within the spirit and scope of the disclosure. The sizes and thicknesses of elements illustrated in the drawings are illustrated arbitrarily for ease of description, and the present disclosure is not limited to those illustrated.

In the drawings, an X-direction may be defined as a first direction or a thickness direction, a Y-direction may be defined as a second direction or a length direction, and a Z-direction may be defined as a third direction or a width direction.

Hereinafter, a coil component according to an example embodiment of the present disclosure will be described in detail with reference to the accompanying drawings. In the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high frequency (HF) inductor, a general bead, a high-frequency bead (GHz bead), a common mode filter, or the like.

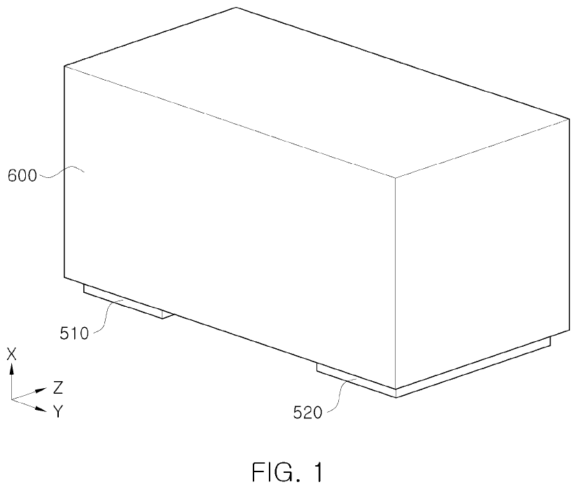

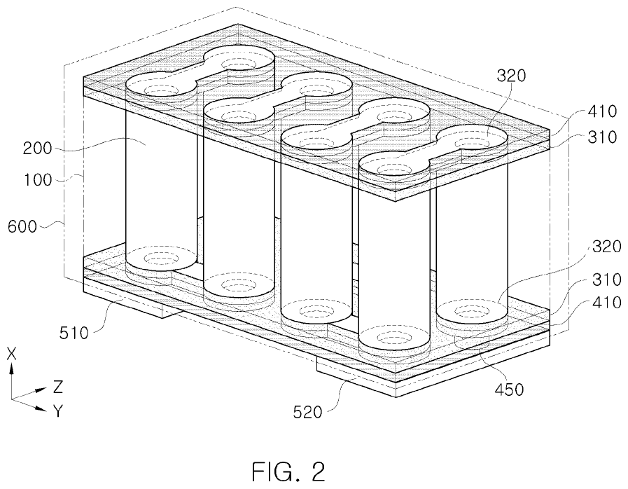

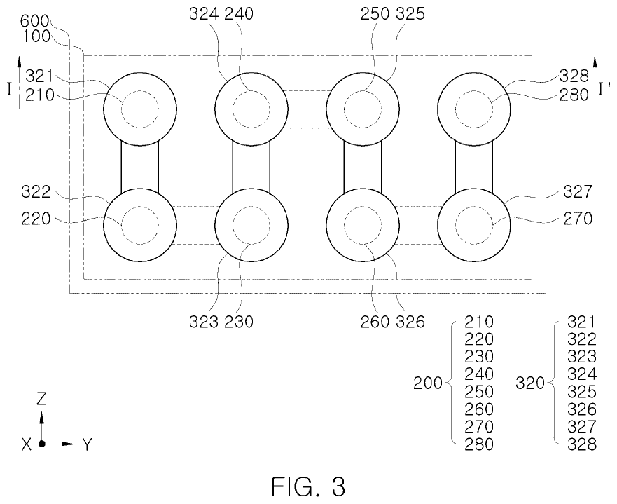

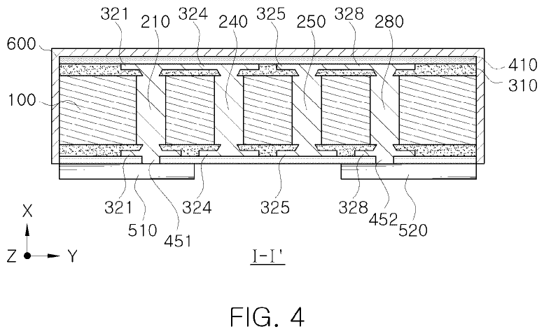

FIG. 1 is a perspective view of a coil component according to an example embodiment of the present disclosure. FIG. 2 is a perspective view of internal elements of the coil component of FIG. 1. FIG. 3 is a top view of the coil component of FIG. 1. FIG. 4 is a cross-sectional view taken along line I-I′ of FIG. 3.

Referring to FIGS. 1 to 4, a coil component 1000 according to an example embodiment of the present disclosure may include a body 100, a plurality of through-vias 200, a plurality of pads 320, a cover insulating layer 410, a via electrode 450, and an external electrode 500, and may further include an insulating film IF, a body insulating layer 310, and an external insulating layer 600.

The body 100 may form an exterior of the coil component 1000 according to the present example embodiment, and a plurality of through-vias 200 may be disposed in the body.

In the directions of FIGS. 1 to 4, the body 100 may have a first surface 101 and a second surface 102 opposing each other in a first direction (X-direction), a third surface 103 and a fourth surface 104 opposing each other in a second direction (Y-direction), and a fifth surface 105 and a sixth surface 106 opposing each other in a third direction (Z-direction). The third to sixth surfaces 103, 104, 105, and 106 of the body 100 may be respectively side surfaces of the body 100, connecting the first surface 101 and the second surface 102 of the body 100 to each other. Hereinafter, the first surface 101 of the body 100 may refer to a lower surface of the body, but the present disclosure is not limited thereto.

The body 100 may include a magnetic material and a resin. Specifically, the body 100 may be formed by laminating one or more magnetic composite sheets in which the magnetic material is dispersed in the resin. However, the body 100 may have a structure other than a structure in which the magnetic material is dispersed in the resin. For example, the body 100 may be formed of a magnetic material such as ferrite, or may be formed of a non-magnetic material.

The magnetic material may be ferrite or metal magnetic powder particles.

The ferrite may be, for example, at least one of spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, or the like, hexagonal ferrite such as Ba—Zn-based ferrite, Ba—Mg-based ferrite, Ba—Ni-based ferrite, Ba—Co-based ferrite, Ba—Ni—Co-based ferrite, or the like, garnet-type ferrite such as Y-based ferrite or the like, or Li-based ferrite.

The magnetic metal powder particles may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder particles may be at least one of pure iron powder particles, Fe—Si-based alloy powder particles, Fe—Si—Al-based alloy powder particles, Fe—Ni-based alloy powder particles, Fe—Ni-Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, or Fe—Cr—Al-based alloy powder particles.

The magnetic metal powder particles may be amorphous or crystalline. For example, the magnetic metal powder particles may be Fe—Si—B—Cr-based amorphous alloy powder particles, but the present disclosure is not necessarily limited thereto.

Each of the ferrite and the magnetic metal powder particles may have an average diameter of about 0.1 μm to about 30 μm, but the present disclosure is not limited thereto.

The body 100 may include two or more types of magnetic materials dispersed in the resin. Here, different types of magnetic materials mean that the magnetic materials dispersed in the resin are distinguished from each other in terms of one of an average diameter, a composition, crystallinity, and a shape.

The resin may include epoxy, polyimide, a liquid crystal polymer, or the like alone or in combination, but the present disclosure is not limited thereto.

A length of the body 100 in the first direction (X-direction) may be less than 500 μm, and specifically, may be 50 μm to 300 μm. The coil component according to the present example embodiment may form a body using a magnetic sheet having a thickness of several tens of micrometers (μm). In this case, a coil component having a desired size and properties may be implemented by adjusting a lamination thickness.

A plurality of through-vias 200 may pass through the body 100. Referring to FIG. 4, the plurality of through-vias 200 may extend to the first surface 101 and the second surface 102 of the body 100, and may completely pass through the body 100.

The coil component 1000 according to the present example embodiment may implement a coil of a coil component using the plurality of through-vias 200. Each through-via can be formed by forming a through-hole in the body (100) and then filling the inside of the through-hole with a metal layer, thereby forming a unit coil. The through-vias can be electrically connected to each other by a plurality of pads (300) described below, and may function as single coil.

Referring to FIGS. 2 and 3, the plurality of through-vias 200 may include first to eighth through-vias 210, 220, . . . , and 280. For ease of description, the plurality of through-vias 200 are referred to as the first to eighth through-vias 210, 220, . . . , and 280 in an order in which the plurality of through-vias 200 are connected to a first external electrode 510 to be described below. However, such a configuration is merely an example, and a coil component including at least two through-vias is included in the example embodiments of the present disclosure.

The plurality of through-vias 200 may be spaced apart from each other in the second direction (Y-direction) or the third direction (Z-direction). Referring to FIG. 3, a first through-via 210 may be spaced apart from a fourth through-via 240, a fifth through-via 250, and an eighth through-via 280 in the second direction (Y-direction). The first through-via 210 may be spaced apart from a second through-via 220 in the third direction (Z-direction).

The plurality of through-vias 200 may be formed by forming a through-hole in the body 100 and filling the through-hole with a conductive material. For example, the conductive material may include copper (Cu), aluminum (Al), silver (Ag), tin (Sn), gold (Au), nickel (Ni), lead (Pb), titanium (Ti), or alloys thereof, and preferably copper (Cu), but the present disclosure is not limited thereto. Each of the plurality of through-vias 200 may include an electroless plating layer (or chemical copper) and an electrolytic plating layer (or electrolytic copper), but the present disclosure is not limited thereto. Instead of the electroless plating layer, a sputtering layer may be formed, and both may be included.

The plurality of pads 320 may be disposed on one surface of the body 100, and may be respectively connected to the plurality of through-vias 200. At least a portion of the plurality of pads 320 may be disposed in the body insulating layer 310 to be described below. The plurality of pads 320 may pass through at least a portion of the body insulating layer 310, and may be connected to the plurality of through-vias 200.

The pads may be formed to correspond to the plurality of through-vias 200, respectively. Specifically, the plurality of pads 320 may include first to eighth pads 321, 322, . . . , and 328, and the first to eighth through-vias 210, 220, . . . , and 280 may be respectively connected to the first to eighth pads 321, 322, . . . , and 328.

The first to eighth pads 321, 322, . . . , and 328 may respectively include a lower pad disposed on the first surface 101 of the body 100, and an upper pad disposed on the second surface 102 of the body 100.

The plurality of pads 320 may electrically connect at least two of the plurality of through-vias 200 to each other. That is, the plurality of pads 320 may serve to electrically connect the plurality of through-vias 200 to each other. Referring to FIG. 3, the first pad 321 may be connected to the second pad 322, on an upper surface of the body, and thus may connect the first through-via 210 and the second through-via 220 to each other. The second pad 322 may be connected to the third pad 323, on a lower surface of the body, and thus may connect the second through-via 220 and the third through-via 230 to each other. The third pad 323 may be connected to a fourth pad 324, on the upper surface of the body, and thus may connect the third through-via 230 and the fourth through-via 240 to each other. The fourth pad 324 may be connected to the fifth pad 325, on the lower surface of the body, and thus may connect the fourth through-via 240 and the fifth through-via 250 to each other. The fifth pad 325 may be connected to the sixth pad 326, on the upper surface of the body, and thus may connect the fifth through-via 250 and the sixth through-via 260 to each other. The sixth pad 326 may be connected to the seventh pad 327, on the lower surface of the body, and thus may connect the sixth through-via 260 and the seventh through-via 270 to each other. The seventh pad 327 may be connected to the eighth pad 328, on the upper surface of the body, and thus may connect the seventh through-via 270 and the eighth through-via 280 to each other.

However, FIGS. 3 and 4 merely illustrate one example of a method in which the plurality of pads 320 are connected to each other, but the present disclosure is not limited thereto.

The plurality of pads 320 may be formed using one of a semi additive process (SAP), a modified semi additive process (MSAP), a tenting process (TT), or a subtractive process, but the present disclosure is not limited thereto. Each of the plurality of pads 320 may include an electroless plating layer (or chemical copper) as a seed layer and an electrolytic plating layer (or electrolytic copper) as a plating layer, but the present disclosure is not limited thereto. A sputtering layer may be formed instead of the electroless plating layer. Copper foil may be further included, as necessary.

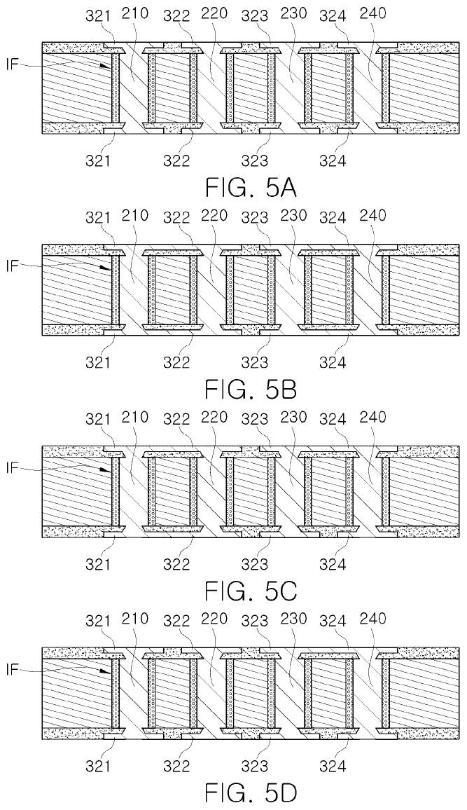

FIGS. 5A to 5D are views of various connection examples of a plurality of through-vias. In FIGS. 5A to 5D, the external electrodes and via electrodes are omitted for clarity.

FIGS. 5 to 8 illustrate, for ease of description, a coil component including four through-vias 210, 220, 230, and 240, but the present disclosure is not limited thereto.

Each of the through-vias 210, 220, 230, and 240 of the coil component according to the present disclosure may serve as a unit coil, and capacitance and properties of the coil component may vary depending on a method in which the through-vias 210, 220, 230, and 240 are connected to each other by a plurality of pads 321, 322, 323, and 324.

Referring to FIG. 5A, the through-vias 210, 220, 230, and 240 may not be connected to each other. Referring to FIG. 5B, the first through-via 210 and the second through-via 220 may be connected to each other in parallel, and the third through-via 230 and the fourth through-via 240 may be connected to each other in parallel. Referring to FIG. 5C, the first through-via 210 and the second through-via 220 may be connected to each other in parallel, and the third through-via 230 and the fourth through-via 240 may be connected to each other in series. Referring to FIG. 5D, the first through-via 210 and the second through-via 220 may not be connected to each other, and the third through-via 230 and the fourth through-via 240 may be connected to each other in series.

As described above, the through-via 200 i) may not be connected to an adjacent through-via, ii) may not connected to the adjacent through-via in parallel, or iii) may not connected to the adjacent through-via in series, by the pad 300.

That is, the pad 320 i) may not be connected to an adjacent pad, ii) may be connected to the adjacent pad on both an upper portion and a lower portion of the body, or iii) may be connected to the adjacent pad on only one of the upper portion and the lower portion of the body.

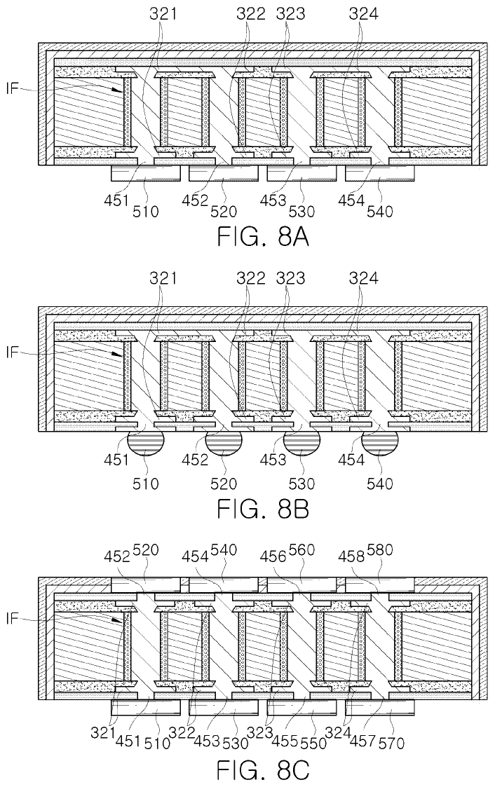

The plurality of through-vias 200 may not be connected to each other, and may form separate coils. Referring to FIG. 5A, the first through-via 210 and the second through-via 220 may not be connected to each other. The first pad 310 and the second pad 320 may not be connected to each other. In addition, as will be described below, one of the plurality of through-vias may be connected to the first and second external electrodes, and another one of the plurality of through-vias may be connected to the third and fourth external electrodes. Referring to FIG. 8A, the first through-via 210 (or the second through-via 220) may be connected to the first and second external electrodes 510 and 520, and the third through-via 230 (or the fourth through-via 240) may be connected to the third and fourth external electrodes 530 and 540.

The plurality of through-vias 200 may be connected to each other in parallel. At least two of the plurality of through-vias 200 may be connected to each other by the pad 320 on the upper portion and the lower portion of the body 100. That is, at least two of the plurality of through-vias 200 may form a closed loop by a plurality of pads. Referring to FIG. 5B, the first pad 321 and the second pad 322 may be connected to each other on the upper portion and the lower portion of the body 100. The first and second through-vias 210 and 220 may form a closed loop by the first pad 321 and the second pad 322.

The plurality of through-vias 200 may be connected to each other in series. At least two of the plurality of through-vias 200 may be connected to each other by the pad 320 on one of the upper portion and the lower portion of the body 100. Referring to FIG. 5C, the third pad 323 and the fourth pad 324 may be connected to each other on the upper portion of the body 100, and may not be connected to each other on the lower portion of the body 100.

Referring to FIG. 5A, an insulating film IF may be disposed between the plurality of through-vias 200 and the body 100. The insulating film IF may be disposed along an inner wall of a through-hole, and may extend to the first surface 101 and the second surface 102 of the body. The insulating film IF electrically insulate between the plurality of through-vias 200 and the body 100.

The insulating film IF may include a known insulating material such as parylene, but the present disclosure is not limited thereto. As another example, the insulating film IF may include an insulating material such as an epoxy resin other than parylene. The insulating film IF may be formed using chemical vapor deposition (CVD) or atomic layer deposition (ALD), but the present disclosure is not limited thereto.

In the present disclosure, the insulating film IF may be an optional element. When the body 100 is capable of securing sufficient electrical resistance under an operating condition of the coil component 1000 according to the present example embodiment, the insulating film IF may be omitted.

The body insulating layer 310 may be disposed on one surface of the body 100. Referring to FIG. 4, the body insulating layer 310 may be disposed on the first surface 101 and the second surface 102 of the body 100. At least a portion of the plurality of pads 320 may be disposed in the body insulating layer 310.

The cover insulating layer 410 may be disposed on the body insulating layer 310. Referring to FIG. 4, the cover insulating layer 410 may be disposed on an upper surface of the body insulating layer 310 disposed on the first surface 101 of the body, and may be disposed on a lower surface of the body insulating layer 310 disposed on the second surface 102 of the body. The cover insulating layer 410 may be disposed on the body insulating layer 310 to cover one surface of each of the plurality of pads 320. The cover insulating layer 410 may prevent the plurality of pads 320 from being exposed to the outside of the component.

The body insulating layer 310 and the cover insulating layer 410 may respectively include an insulating material. As the insulating material, an insulating resin such as a thermosetting resin such as an epoxy resin, or a thermoplastic resin such as polyimide, or a material in which the above-described resins are mixed with an inorganic filler such as silica, or a resin impregnated into a core material such as a glass fiber together with the inorganic filler, for example, an Ajinomoto build-up film (ABF), a prepreg, or the like may be used, but the present disclosure is not limited thereto.

The via electrode 450 may pass through the cover insulating layer 410, and may be connected to the plurality of pads 320. The via electrode 450 may serve to connect external electrodes 510 and 520 to be described below and the plurality of pads 320 to each other.

The via electrode 450 may include a first via electrode 451 connecting a first external electrode 510 and one of the plurality of pads to each other, and a second via electrode 452 connecting a second external electrode 520 and another one of the plurality of pads to each other. Referring to FIG. 4, the first via electrode 451 may connect the first external electrode 510 and the first pad 321 to each other, and the second via electrode 452 may connect the second external electrode 520 and the eighth pad 328 to each other, but the present disclosure is not limited thereto. As will be described below, the coil component may include two or more external electrodes, and the number of via electrodes may be formed to correspond to the number of external electrodes. For example, referring to FIG. 8A, the coil component may include first to fourth external electrodes 510, 520, 530, and 540, and may include first via electrodes 451, 452, 453, and 454 corresponding thereto.

Each via electrode 450 may include a metal, and the metal may include copper (Cu), aluminum (Al), silver (Ag), tin (Sn), gold (Au), nickel (Ni), lead (Pb), titanium (Ti), or alloys thereof, and preferably may include copper (Cu), but the present disclosure is not limited thereto. Each via electrode 450 may include an electroless plating layer (or chemical copper) and an electrolytic layer (or electrolytic copper), but the present disclosure is not limited thereto. A sputtering layer may be formed instead of the electroless plating layer, or both may be included.

The external electrode 500 may be disposed on one surface of the cover insulating layer 410.

The external electrode 500 may include the first and second external electrodes 510 and 520 spaced apart from each other in the second direction (Y-direction). The first and second external electrodes 510 and 520 may be disposed on the first surface 101 of the body 100. Referring to FIG. 4, the first and second external electrodes 510 and 520 may be disposed on a lower surface of the cover insulating layer 410 on a lower portion of the body 100 to be spaced apart from each other.

The external electrode 500 may be connected to the through-via 200 through the via electrode 450. Referring to FIG. 4, the first external electrode 510 may be connected to the first pad 321 through the first via electrode 451, and the second external electrode 520 may be connected to the eighth pad 328 through the second via electrode 452. Accordingly, the plurality of through-vias 200 may serve as a coil in the coil component.

The first and second external electrodes 510 and 520 may have a structure including a single layer structure or a plurality of layers. For example, the first external electrode 510 may include a first layer including copper (Cu), a second layer disposed on the first layer, the second layer including nickel (Ni), and a third layer disposed on the second layer, the third layer including tin (Sn). Here, the first to third layers may be formed by plating, respectively, but the present disclosure is not limited thereto. As another example, the first external electrode 500 may include a resin electrode including conductive powder particles, such as silver (Ag), and a resin, and a nickel (Ni)/tin (Sn) plating layer formed on the resin electrode.

The first and second external electrodes 510 and 520 may be formed of a conductive material such as copper (Cu), aluminum (Al), silver (Ag), tin (Sn), gold (Au), nickel (Ni), lead (Pb), titanium (Ti), or alloys thereof, but the present disclosure is not limited thereto.

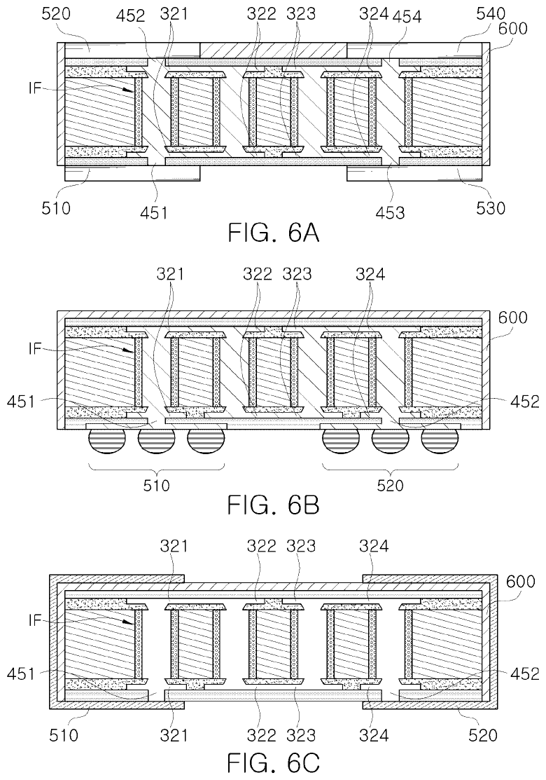

FIGS. 6A to 6C are views of coil components according to a modification of the present disclosure.

Referring to FIG. 6A, the external electrode 500 may be disposed on the first surface 101 or the second surface 102 of the body 100. Specifically, the external electrode 500 may be disposed on a lower surface of the cover insulating layer 410 on a lower portion of the body 100, or may be disposed on an upper surface of the cover insulating layer 410 on an upper portion of the body 100. Accordingly, when the coil component 1000 includes the first and second external electrodes 510 and 520, both the first and second external electrodes may be disposed on the first surface 101 (or the second surface 102) of the body 100, or the first and second external electrodes may be disposed respectively on the first surface 101 and the second surface 102 (or vice versa).

Referring to FIG. 6B, the external electrode 500 may be in the form of a solder ball, and the coil component 1000 may be used as a ball grid array (BGA) substrate or the like.

Referring to FIG. 6C, the external electrode 500 may extend onto an external insulating layer 600 to be described below, and may also be disposed on a side surface and an upper surface of the body.

The external insulating layer 600 may be disposed on the second to sixth surfaces 102, 103, 104, 105, and 106 of the body 100. The external insulating layer 600 may serve to protect the body 100 such that the body 100 is not exposed to the outside of the coil component.

Specifically, the external insulating layer 600 may be disposed on the third to sixth surfaces 103, 104, 105, and 106 of the body 100, and may be disposed on the upper surface of the cover insulating layer 410. The external insulating layer 600 may be disposed in a region in which the external electrode is not formed to expose the external electrode 500. The external insulating layer 600 may serve as a plating resist when the external electrode 500 is formed by plating, but the present disclosure is not limited thereto.

The external insulating layer 600 may be disposed on a surface of the body 100 on which the external electrode 500 is not formed, and may serve to electrically protect the coil component, reduce leakage current, and prevent plating spread during formation of the external electrode.

The external insulating layer 600 may include a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, or the like, a photosensitive resin, parylene, SiOₓ or SiNₓ.

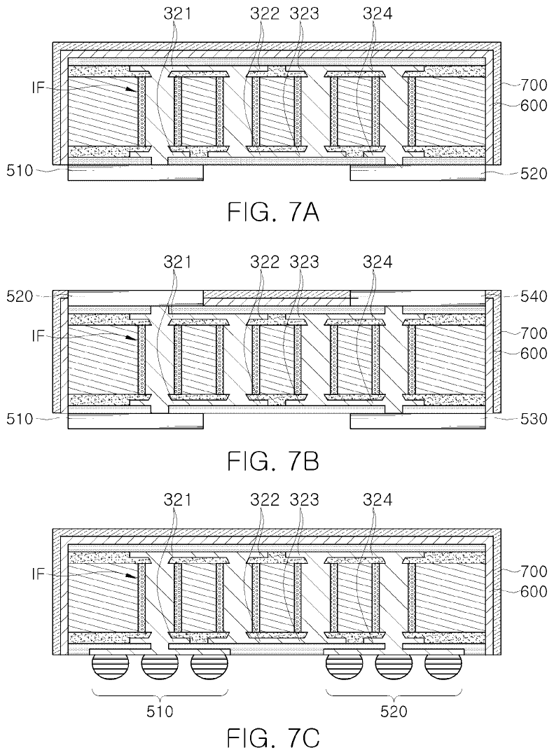

FIGS. 7A to 7C are views of coil components according to another modification of the present disclosure.

According to FIG. 7, a coil component according to a modification may further include a metal layer 700 disposed on an external insulating layer 600.

The metal layer 700 may be directly disposed on a surface of the external insulating layer 600 along the surface. The metal layer 700 may not cover an external electrode 500, and may allow the external electrode 500 to be exposed to the outside of the component.

The metal layer 700 may block radiation noise leaking to the outside from the coil component and/or noise flowing into the coil component from the outside.

The metal layer 700 may include a conductive material and, for example, may include at least one of silver (Ag), copper (Cu), aluminum (Al), tin (Sn), gold (Au), nickel (Ni), lead (Pb), or titanium (Ti).

FIGS. 8A to 8C are views of coil components according to another modification of the present disclosure.

Referring to FIG. 8, at least two of a plurality of through-vias 200 in a coil component may not be connected to each other. That is, the coil component may be in the form of an array-type coil component including a plurality of coils.

Referring to FIG. 8A, the coil component may include first to fourth external electrodes 510, 520, 530, and 540. The first to fourth external electrodes 510, 520, 530, and 540 may be disposed on a first surface 101 of a body 100 to be spaced apart from each other in a second direction (Y-direction). A first through-via 210 (or a second through-via 220) may be connected to the first and second external electrodes 510 and 520, and a third through-via 230 (or a fourth through-via 240) may be connected to the third and fourth external electrodes 530 and 540.

Referring to FIG. 8B, the first to fourth external electrodes 510, 520, 530, and 540 may be in the form of solder balls, and the coil component 1000 may be used as a BGA substrate or the like.

Referring to FIG. 8C, the coil component may include first to eighth external electrodes 510, 520, . . . , and 580. The first, third, fifth, and seventh external electrodes 510, 530, 550, and 570 may be disposed on the first surface 101 of the body 100 to be spaced apart from each other in the second direction (Y-direction), and the second, fourth, sixth, and eighth external electrodes 520, 540, 560, and 580 may be disposed on a second surface 102 of the body 100 to be spaced apart from each other in the second direction (Y-direction). Each of through-vias 210, 220, . . . , and 280 may be connected to two external electrodes. For example, a first through-via 210 or 220 may be connected to the first and second external electrodes 510 and 520.

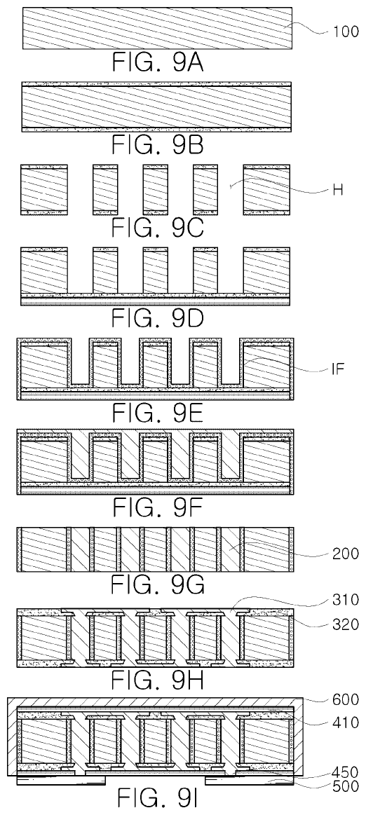

FIGS. 9A to 9I are views of a manufacturing process of a coil component according to the present disclosure.

Referring to FIG. 9A, a body 100 may be formed by laminating a plurality of magnetic sheets having a thickness of several tens of micrometers (μm).

Referring to FIG. 9B, a cover may be formed on each of an upper portion and a lower portion of the body 100.

Referring to FIG. 9C, a through-hole H passing through the body 100 may be formed using a CNC drill, a laser process, or the like.

Referring to FIG. 9D, a carrier may be attached to the lower portion of the body 100.

Referring to FIG. 9E, an insulating film IF may be formed on an inner wall of the through-hole H using chemical vapor deposition, atomic layer deposition, or the like.

Referring to FIG. 9F, a conductive material may be filled in the through-hole H.

Referring to FIG. 9G, the carrier may be removed using a polishing process or the like. As a result, a plurality of through-vias 200 may be completed to form a unit coil.

Referring to FIG. 9H, a body insulating layer 310 and a plurality of pads 320 may be formed on the upper portion and the lower portion of the body 100. The plurality of pads 320 may pass through at least a portion of the body insulating layer 310, and may be connected to the plurality of through-vias 200. The coil component according to the present example embodiment may be implemented as desired depending on a method in which the plurality of pads 320 are connected to each other, such as serial or parallel connection between the plurality of through-vias 200. That is, a coil component having desired capacitance and properties may be freely implemented depending on a method in which the plurality of pads 320 are connected to each other.

Referring to FIG. 9I, a cover insulating layer 410 and via electrodes 450 may be formed on the upper portion and the lower portion of the body 100, and an external insulating layer 600 and external electrodes 500 may then be formed.

While example embodiments have been shown and described above, it will be apparent to those skilled in the art that modifications and variations could be made without departing from the scope of the present disclosure as defined by the appended claims.

What is claimed is:

1. A coil component comprising:
a body;
a plurality of through-vias passing through the body;
a plurality of pads disposed on a surface of the body, the plurality of pads respectively connected to the plurality of through-vias;
a cover insulating layer covering a surface of the plurality of pads;
an external electrode disposed on a surface of the cover insulating layer; and
a via electrode passing through the cover insulating layer, the via electrode connecting the external electrode and the plurality of pads to each other.

2. The coil component of claim 1, wherein
the body has a first surface and a second surface opposing each other in a first direction, a third surface and a fourth surface connecting the first surface and the second surface to each other, the third surface and the fourth surface opposing each other in a second direction, and a fifth surface and a sixth surface connecting the third surface and the fourth surface to each other, the fifth surface and the sixth surface opposing each other in a third direction, and
the plurality of through-vias extend to the first surface and the second surface.

3. The coil component of claim 2, wherein
the plurality of through-vias are spaced apart from each other in the second direction, and
the external electrode includes a first external electrode and a second external electrode spaced apart from each other in the second direction.

4. The coil component of claim 3, wherein the via electrode includes a first via electrode connecting the first external electrode and a first pad of the plurality of pads to each other, and a second via electrode connecting the second external electrode and a second pad of the plurality of pads to each other.

5. The coil component of claim 3, wherein the first external electrode and the second external electrode are disposed on the first surface of the body.

6. The coil component of claim 3, wherein the first external electrode is disposed on the first surface of the body, and the second external electrode is disposed on the second surface of the body.

7. The coil component of claim 1, wherein the plurality of pads connect at least two through-vias of the plurality of through-vias to each other.

8. The coil component of claim 1, wherein the plurality of pads include a plurality of lower pads disposed on the first surface of the body, and a plurality of upper pads disposed on the second surface of the body.

9. The coil component of claim 7, wherein at least two of the plurality of through-vias form a closed loop by the plurality of pads.

10. The coil component of claim 1, wherein the external electrode includes a first external electrode, a second external electrode, a third external electrode, and fourth external electrode spaced apart from each other.

11. The coil component of claim 10, wherein:
a first through-via of the plurality of through-vias is connected to the first external electrode and second external electrode, and
a second through-via of the plurality of through-vias is connected to the third external electrode and fourth external electrode.

12. The coil component of claim 1, further comprising:
an insulating film disposed between the plurality of through-vias and the body,
wherein the insulating film extends to the surface of the body.

13. The coil component of claim 1, further comprising:
a body insulating layer disposed directly on the surface of the body,
wherein the body insulating layer is disposed between the body and the cover insulating layer, and
at least a portion of the plurality of pads is disposed in the body insulating layer.

14. The coil component of claim 2, further comprising:
an external insulating layer disposed on the second surface, the third surface, the fourth surface, the fifth surface, and the sixth surface of the body, the external insulating layer exposing the external electrode.

15. The coil component of claim 14, further comprising:
a metal layer disposed on the external insulating layer, the metal layer exposing the external electrode.
